(19) United States
(12) Patent Application Publication
(10) Pub. No.: US 2011/0191236 A1
(43) Pub. Date: Aug. 4, 2011

(54) Virtual card

(75) Inventors: Mike Cummings, Los Altos, CA (US); Gary Daniel, San Jose, CA (US)

(73) Assignee: QSECURE, INC., Los Altos, CA (US)

(21) Appl. No.: 12/931,352

(22) Filed: Jan. 27, 2011

Related U.S. Application Data
(60) Provisional application No. 61/298,908, filed on Jan. 27, 2010.

(51) Int. Cl. G06Q 40/00; G06K 19/06

(52) U.S. Cl. 705/39; 235/494

(57) ABSTRACT

A system for securing a financial transaction that includes a back-end unit for generating a value that is used in the financial transaction, a central communication engine for receiving the value from the unit, wherein the engine is capable of receiving and sending the value securely, and a device that includes a processor, a communication module for receiving the value, and a memory unit for storing the value, and a display for providing information related to the value, wherein the information secures the financial transaction.

### CROSS-REFERENCE AND RELATED APPLICATION

Pursuant to 35 U.S.C. §119 (e), this application claims priority to the filing date of U.S. Provisional Patent Application Ser. No. 61/298,908 filed on Jan. 27, 2010 and titled VIRTUAL CARDS, the disclosure of which application is incorporated herein by reference.

This application incorporates by reference U.S. application Ser. No. 11/871,797 filed on Oct. 12, 2007 and entitled PAYMENT CARD MANUFACTURING TECHNOLOGY.

### Field of the Invention

This invention is related to electronic systems involved in a financial transaction, and more specifically, to a portable electronic device with a virtual financial instrument for conducting a financial transaction.

### BACKGROUND

Some card form factors use a static magnetic-stripe. Recently, there have been some cards introduced that utilize a display that provides information to a user. Alternatively, some cards use a dynamic magnetic stripe. These card form factors typically include an internal memory that stores the information that is provided. Most of these card form factors include the use of a dynamic magnetic stripe. Additionally, the use of a token or a card form factor has several disadvantages. For example, there are limitations and the inclusion of electronic components is challenged by the limitation of the environment. There are also pricing consideration given that the cost of each card needs to be kept to a minimum, especially given that cards are often lost, damaged or destroyed and need to be replaced.

Therefore, what is needed is a system and method that allows a consumer to use a portable device to conduct, in a secure manner, multiple financial transactions without the need to carry independent devices to secure each financial transaction instrument. Furthermore, what is needed is a system and method that allows the consumer to receive information needed to complete a financial transaction.

### SUMMARY

A system and method are disclosed in accordance with the teaching of the present invention that allows a user to control multiple financial transaction instruments using a portable electronic device. In accordance one teaching of the present invention, the use of a card or traditional form factor may be combined with the use of a portable device for creating a secure virtual card. In accordance with one aspect of the present invention, the device receives information through a wired or wireless connection and the information is used to generate dynamic values associated with each of the instruments or cards.

### BRIEF DESCRIPTION OF THE DRAWINGS

FIG. 1 shows a system for sending information from a trusted source to a portable device.

FIG. 2 shows a flow process for generating a value that is used in a financial transaction.

### DETAILED DESCRIPTION

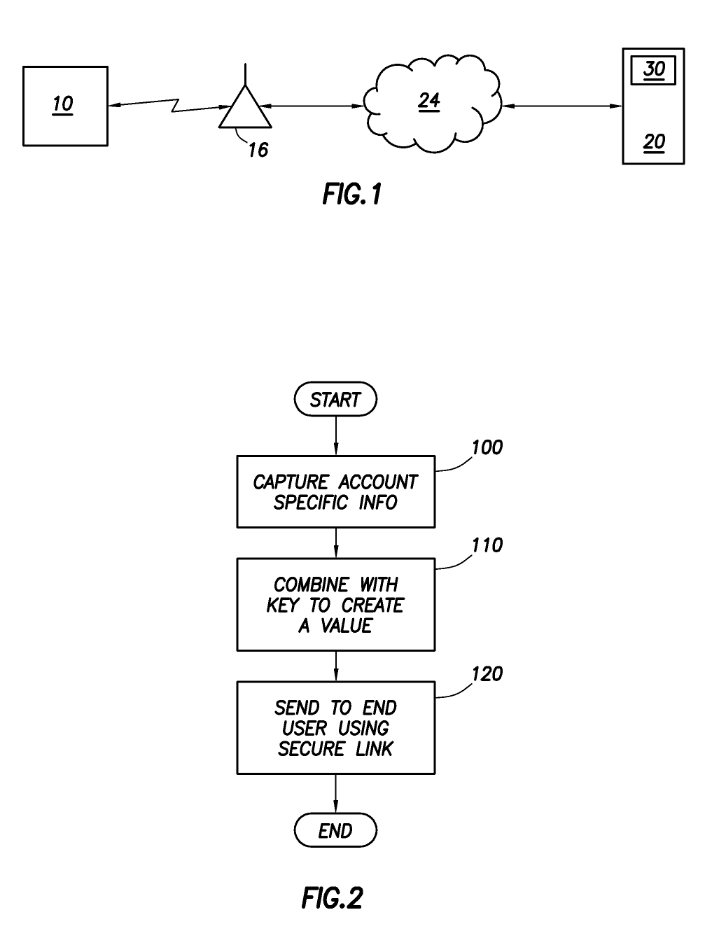

Referring now to FIG. 1, a system 10 is located at a trusted source, such as at a bank or a processor. In accordance with one aspect of the present invention, the system 10 generates a value or a table of values that are used to create a series of dynamic numbers that can be used in a financial transaction. In accordance with another aspect of the present invention, the system 10 may generate a limited number of values that are sent in response to a request for new values that will be used to create a dynamic number. The system 10 sends the values to a provisioning engine 16. The engine 16 securely receives the values from the system 10. The engine 16 establishes a connection with a portable device 20 through the internet 24. The engine 16 provides programs and applications/updates to the device 20. In accordance with one aspect of the present invention, the engine 16 can also store the values and provide the values to the device 20 when the device 20 has used all of the values stored at the device 20. In accordance with another aspect of the present invention, the engine 16 generates the values based on information provided by the system 10 and the engine 20 acts as a trusted source.

The portable device 20 includes a memory, a processor, a display, and means for communicating, either through a land-line/wired connection or a through wireless connection. The value or values stored on the device 20 may be encrypted or kept hidden until the user enters a security PIN or unlocks the secure portion of the device 20 where the value is stored. In accordance with the various aspects of the present invention, the wireless device may include any of the following: personal digital device, portable computer, mobile telephone, a smart phone, a computer, or any other electronic device that includes the desired features of a memory, a processing unit, and a display.

In accordance with another aspect of the present invention, the device 20 may be physically connected to a secure network and the engine 16 would communicate with the device 20 through the secure network instead of the internet 24.

Once the device 20 is in communication with the engine 16, the engine 16 uses the secure communication link to provide or download the necessary application programs that run on the device 20 as well as the values.

The device 20 uses the values as part of a financial transaction. In accordance with one aspect of the present invention, the device 20 provides the values directly to a Point-of-Sale device in the form of a bar code or through a wireless transmission. The device 20 may use the values to generate a dynamic number that is included as part of the message that represent the financial instrument and the transaction. The message is sent to the bank and the system 10 ate the bank can confirm the value or dynamic number that was included in the message. In accordance with another aspect of the present invention, the device 20 may provide the value as a one-time password. Once the value is used, a new value is used for the next transaction. The system 10 receives the value used as part of the financial transaction and, thus, able to confirm that the consumer is authorized to use the account and that the transaction is not fraudulent.

As indicated above, the system 10 may provide any quantity of values. In accordance with one aspect of the present invention, the system 10 provides up to twenty numbers at a time to the device 20. In accordance with another aspect of the present invention, the system 10 provides one value at a time to the device 20. In accordance with yet another aspect of the present invention, the system 10 provides a table to 3000 values.

The device 20 includes a display 30 for displaying the value to the user or for providing a bar-code like image for scanning. In accordance with another aspect of the present invention, the device 20 may display a value that represents a virtual card. For example, the device 20 may have an interface that looks like a payment card or an ISO card and that displays payment account information like account number, expiration date, name of cardholder, issuer name or logo, etc. In accordance with the various teaching of the present invention, the device 20 may represent multiple accounts of the same type or multiple accounts each of a different type, such as a credit, a debit, or a reward instrument or card. The user may add any number of accounts to the device 20 and is limited only by the storage capacity of the device 20. In accordance with another aspect of the present invention, the display 30 of the device 20 can provide a dynamic code that is derived or based on the value provided by the system 10.

In accordance with another aspect of the present invention, the device 20 uses a value for payment or authentication transactions like OTP (one Time Password), 3D Secure, Verified by Visa, Secure Code or dynamic CW, CVC, CID or 4DBC, eCommerce, MOTO (Mail Order Telephone Order).

In accordance with another aspect of the present invention, the device 20 can provide information for or associated with multiple financial transaction instruments or tokens and that value in the display may be changed between instruments as needed through an interface changes of the display 30.

In accordance with another aspect of the present invention, a table of values can be preloaded or accessed remotely using a secure interface using cryptography that doesn't reside in the device 20, or use a local subset of the remote table of security codes. This local subset is maintained in a background process invisible to the user.

In accordance with various aspect of the present invention, there are various models or processes associated with how the virtual card application can be loaded into the device for procurement of personal data and provisioning, which processes can be secured by personal credentials or a personal PIN, including:

1) An application that can be installed over the air or through other means;

2) An interface in the application that can allow for the selection of the targeted issuer or that can be predefined;

3) An authentication process that allows the user to initialize the interface with the relevant graphics and personal information needed for the application to work; and

4) Supports access to a local table or to a server to get the next dynamic number to display in the display window.

Additional feature and extension that can be added, including:

1) Local storage of the full table of values that represent dynamic codes;

2) A partial table refilled automatically in accessing a server;

3) Options to use geo location feature of the device or/and device specific information to strengthen the security of transactions;

4) Capacity to remotely delete all information in the application or deactivate the application; and

5) Periodically (to enhance security) the server will send a command to the mobile causing it to erase its unused CW table entries and then fresh CWs will be sent by the server. In this way, if the mobile's codes have been compromised and loaded onto a fraudulent mobile device, the server will be aware of those stale codes and score those authorization messages as fraudulent.

Referring now to FIG. 2, the process of generating and sending a value to the device 20, of FIG. 1, is shown. At step 100, specific information associated with the consumer account is selected. The information may include account numbers, expiration dates, user name, or any other information associated with the account. At step 110, the selected information is used along with a specific “key” to generate a unique value. The key is known to the trusted source or system 10 and can be shared as determined by the trusted source. The scope of the present invention is not limited by the type or method used to encrypt or generate the value. At step 120, the unique value or group of values is sent to the engine 16. In accordance with various aspects of the present invention, the unique values may be generated individually or as a group and the scope of the present invention is not limited by the quantity of values generated.

It is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

It is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A system for securing a financial transaction, the system comprising
a unit for generating a value that is used in the financial transaction;
a communication engine for receiving the value from the unit, wherein the communication engine is capable of receiving and sending the value securely; and
a device comprising:
a processor;
a communication module for conducting a secure communication session with the communication engine to receive the value;
a memory unit for storing the value; and
a display for providing information related to the value, wherein the information secures the financial transaction.

2. The system of claim 1, wherein the information is a visual representation of the value in numeric form.

3. The system of claim 1, wherein the information is a bar code representation of the value.

4. The system of claim 1, wherein the information is a dynamic number replaces a portion of an account number being used in the financial transaction and wherein the dynamic number is sent as part of the financial transaction message.

5. The system of claim 1, wherein the information is a value that is included as part of the financial transaction message and sent in the discretionary data field.
